(19) United States
(12) Patent Application Publication
(10) Pub. No.: US 2020/0387219 A1
(43) Pub. Date: Dec. 10, 2020

(54) Devices And Methods For Reducing Computational And Transmission Latencies In Cloud Based Eye Tracking Systems

(71) Applicant: EyeTech Digital Systems, Inc., Mesa, AZ (US)

(72) Inventors: Robert C. Chappell, Mesa, AZ (US); Caleb R. Hinton, Mesa, AZ (US); Michael S Holford, Gilbert, AZ (US); William B. Whitehead, Mesa, AZ (US)

(21) Appl. No.: 16/781,965

(22) Filed: Feb. 4, 2020

Related U.S. Application Data
(62) Division of application No. 16/434,830, filed on Jun. 7, 2019.

(51) Int. Cl. G06F 3/01; G06F 3/00; H04L 29/08; G06K 9/32; G06K 9/00; H04N 5/232; H04L 12/26

(52) U.S. Cl. CPC G06F 3/013; G06F 3/005; H04L 67/10; G06K 9/3216; H04L 43/0852; H04N 5/23219; H04L 43/10; H04N 5/232061; G06K 9/00248

(57) ABSTRACT

Systems and methods for cloud-based eye tracking with reduced computing and network overhead are provided. Computational latency is reduced by isolating an eye region within a facial image and transmitting it to the remote server for further image processing. Transmission latency is reduced by identifying available servers on the network, assigning transmission latency values to each server based on various attributes, and proactively selecting the server having the lowest transmission latency.

### CROSS REFERENCE TO RELATED APPLICATIONS

This application claims priority to co-pending U.S. patent application Ser. No. 16/434,830 filed Jun. 7, 2019 and entitled “Devices and Methods For Reducing Computational and Transmission Latencies in Cloud Based Eye Tracking Systems”.

### TECHNICAL FIELD

The present disclosure relates, generally, to eye tracking devices associated with a client computer and, more particularly, to techniques for minimizing computation and transmission latencies when transmitting eye tracking image data over a network to a cloud-based server configured to process the image data.

### BACKGROUND

Eye tracking is an assistive technology for facilitating computer access without the use of a keyboard or mouse. Computers equipped with an eye tracker device allow differently abled persons to effectively interact with computers and navigate applications using only their eyes. Eye trackers are also used in gaming, virtual reality, research, and medical applications, either as an add-on accessory or seamlessly integrated into a native computer such as a tablet, laptop, or desk top. State of the art eye tracking products are available from Eyetech™ Digital Systems located in Mesa, Ariz., and Tobii™ Tech located in Stockholm, Sweden.

The essential components of an eye tracking camera include an image sensor, a lens, at least one illuminator (e.g., a near field infrared (IR) LED), a processor, and data link for communicating with the native computer to which the tracker is attached. Presently known trackers include robust processors for performing computationally intensive image processing on the image data captured by the sensor. Performing complex image processing functions in real time (or near real time) requires high performance microprocessors and associated high speed random access memory (RAM), which tend to increase the cost of the device hardware.

Systems and methods are thus needed which overcome the limitations of presently known eye tracking devices.

### SUMMARY

The present invention proposes to minimize the essential eye tracking device hardware, to thereby reduce cost, size, and complexity, while still allowing real time or near real time processing of eye movement. In accordance with one aspect of the disclosure, the tracking device includes a low cost camera and microprocessor, along with a cloud based processing scheme in which the complex image processing functions are performed remotely. In order to achieve real time performance, the present invention further contemplates various techniques for minimizing the computational and transmission latencies inherent in cloud based processing regimes.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a schematic block diagram depicting exemplary architecture in which techniques and structures for providing the systems and methods disclosed herein may be implemented in accordance with various embodiments;

FIG. 2 is a schematic diagram illustrating the use of a full facial image and determination of an eye region(s), as well as subsequent use of the eye region(s) in accordance with various embodiments;

FIG. 3 is a flowchart of an exemplary method of mitigating computational latency in accordance with various embodiments;

FIG. 4 is a flowchart of an exemplary method of reconciling eye location and eye position information in accordance with various embodiments;

FIG. 5 is a flowchart of an exemplary initialization routine in accordance with various embodiments; and

FIG. 6 is an exemplary array of available processing resources and associated attributes identified during the initialization routine of FIG. 5.

### DETAILED DESCRIPTION

The present invention employs a cloud based processing regime, wherein all or a significant portion of the image processing is performed remotely rather than locally. Consequently, both computational latencies (the time required to perform the image processing) and transmission latencies (the time required for the data to travel from the client device to the cloud based server and back again) are introduced. Various techniques are described for minimizing computational and transmission latencies, so that real time operation may be achieved notwithstanding the physical separation between the eye tracking device and the cloud based server.

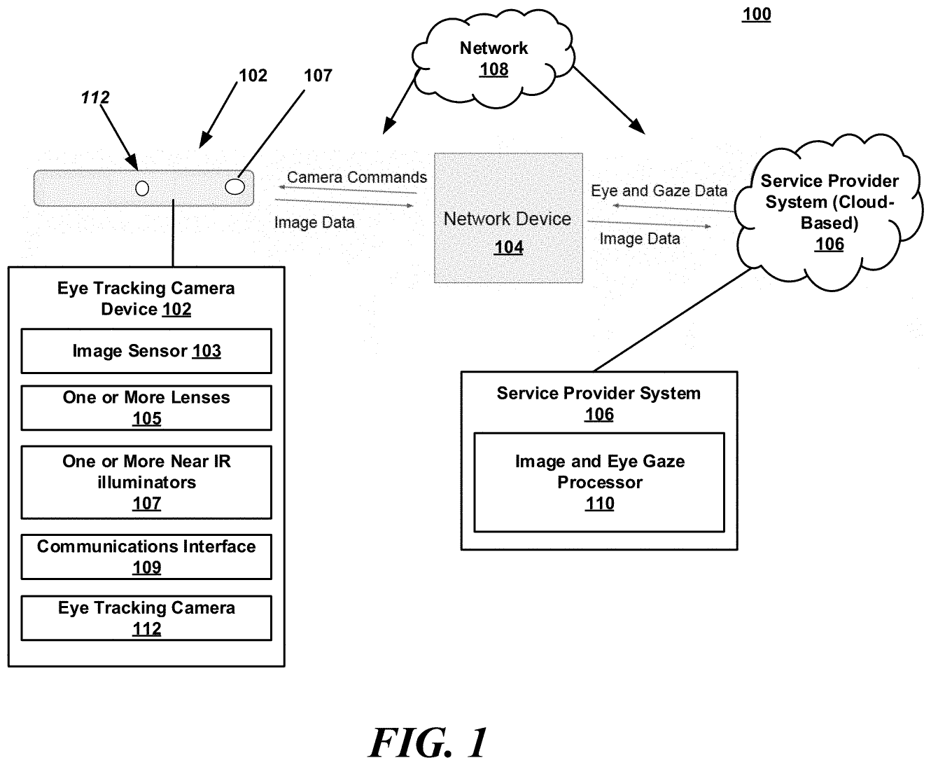

Techniques for mitigating computational latencies include: i) isolating the eye regions of the captured image and cropping or truncating the remaining data; ii) data compression including only processing the differences between successive data frames; iii) predictive image cropping based on previous data frames; and iv) selecting an optimal server configuration from the available processing resources (e.g., compatible chip sets). These techniques are discussed in greater detail below in conjunction with FIGS. 1-4.

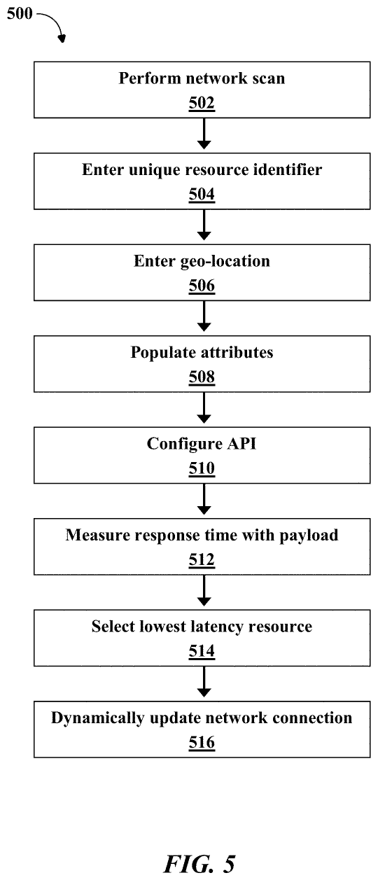

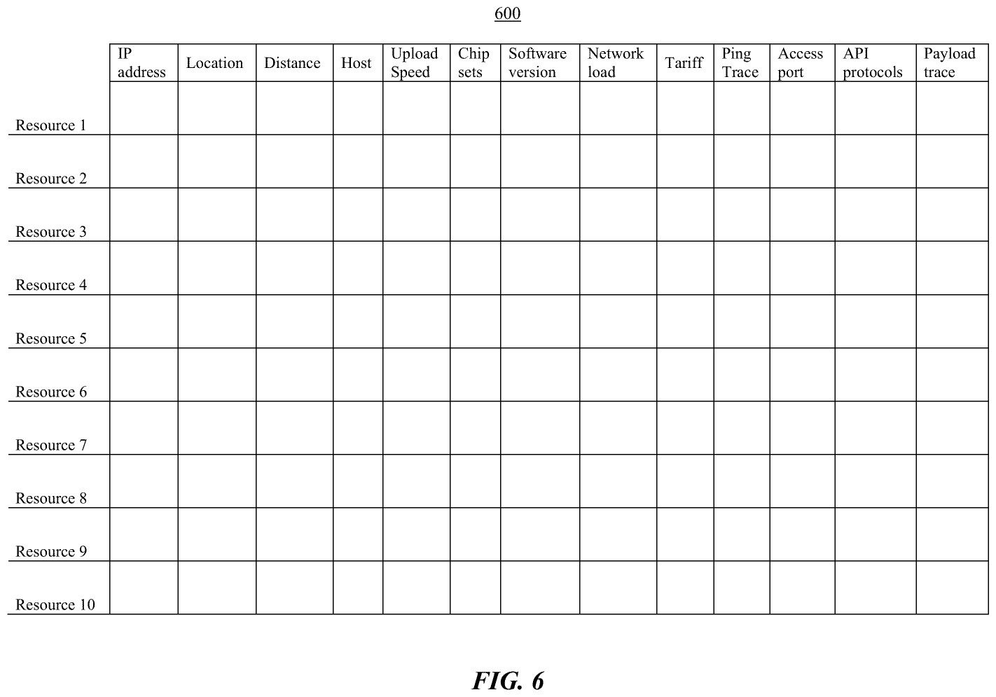

Techniques for mitigating transmission latencies are described below in conjunction with FIGS. 5 and 6 and include: i) selecting geographically proximate cloud based resources; ii) selecting networks with high upload bandwidth capability; and iii) selecting and/or dynamically configuring network connections which exhibit low transmission latencies. In this context the term “bandwidth” generally refers to the average amount of data which can be transmitted by the network per unit of time (typically expressed in Megabits per second (Mb/s)), or simply the data transfer rate.

Publically available cable and cellular networks are typically asymmetric; that is, they have higher download speeds than upload speeds, primarily to accommodate user demand for audio and video streaming. 4G cellular networks operated by Verizon, AT&T, T-Mobile, and Sprint exhibit download to upload bandwidth ratios in the range of about 3. Cable networks currently offer download/upload ratios closer to ten (10). Data travels at approximately 120,000 miles (or 192,000 kilometers) per second, or 120 miles (192 km) per millisecond over a typical network connection, resulting in roughly 1 ms of latency for every 60 miles (96 km) of distance between the client and cloud based server. Moreover, the design, selection, arrangement, and scale of the various hardware components comprising cellular and cable network infrastructure can vary from city to city, with upgrades driven by demand. Thus, in addition to the geographic distance between the client and the server, latency may also be influenced by the location of the server and may change over time.

In contrast to most cloud based processing regimes, which involve low bandwidth uploads and high bandwidth downloads, eye tracking applications require uploading large amounts of image data, and downloading relatively small data sets. Users are willing to accept latencies in the range of seconds or even minutes for non-real time tasks such as downloading software applications, video files, or search results from cloud based servers. Real time applications such as eye tracking programs, on the other hand, require a much narrower latency envelope for proper performance. In this context, “real time” implies a total combined computational and (round trip) transmission latency of less than about 200 milliseconds (ms), and preferably about 50-60 ms, and most preferably under 20 ms (e.g., 5-10 ms). It is therefore advantageous to utilize a network having high upload bandwidth (regardless of download capacity).

In addition to bandwidth (network speed) limitations, transmission latency is also impacted by the amount of time required to transmit data from the tracker to the cloud based server and back again. For example, a user located in Phoenix, Ariz. with a network connection to a server located 30 miles away in Tempe, Ariz. may experience a 1 to 2 ms latency attributable to the distance between the client and the server. That same user utilizing the same network but connected to an identically configured server located in Portland, Oreg. may experience a 16 to 18 ms latency attributable to the geographic distance between Phoenix and Portland.

It is therefore advantageous to configure the network connection to minimize the physical distance between the user and the cloud based server to thereby minimize transmission latency (as opposed to processing latency, discussed below). In other embodiments, the geographic distance between the client and the server is but one of several factors to be considered when configuring a network connection.

For example, the network device (e.g., the desk top or laptop computer to which the tracker is coupled) may be configured to run a start-up routine which includes performing an initial scan on one or more cellular and/or cable networks to identify available processing resources. In this context, a remote server is considered to be an available resource if a connection can be established, and if it is then currently running the server side software application(s) necessary to support an interactive session with the client computer. To accommodate the different chip sets, hardware, and software configurations operating on competing hosted servers, both the client and server the eye tracking software may be genericized or otherwise adapted to operate on all or a subset of the then-current hosted server platforms. For example, the eye tracking software should be interoperable on any number of hardware platforms hosted by one or more of the following commercial cloud vendors: Microsoft, Amazon, IBM, Oracle, and Google. The software should also be compatible with prevailing industry trends, standards, and processing paradigms including preferred chip sets such as those available from Xilinx of San Jose, Calif. and the Xeon chips available from Intel of Santa Clara, Calif. In this way, the eye tracking device may be agnostic to the cloud vendor, such that a network connection may be established based on geographic proximity and the other metrics discussed herein.

Upon performing an initial scan, an array of candidate processing resources is compiled, which may include indicia of one or more of the following attributes for each resource: cloud hosting vendor; geo-coordinates; upload bandwidth; chip set manufacturer and salient configuration details; software version; current network traffic load; tariffs (if any); IP address(es); traceroute value; available ports; and API information and configuration details. In this context the traceroute value corresponds to the time value returned by a tracer ping using any available ping event or pinging tool such as those offered by Pingman Tools of Boise, Id. Based on the foregoing, the start-up routine can identify and/or prioritize one or more processing resources and select an initial network connection.

In another embodiment, the start-up protocols may employ a “ping” type query coupled with an exemplary payload. In this regard, each commercial cloud vendor publishes its own suite of APIs. The eye tracking software may be configured to execute, for each cloud vendor's API, an appropriate call, handshake, or other interactive feature which allows the eye tracker to send an exemplary image data set to the server for preliminary processing and receive a responsive location or other data in return. The actual processing and transmission latency for each candidate resource may then be added to the array, and a network connection established with that resource exhibiting the lowest latency.

In a further embodiment, the start-up routine may also return information about both the general purpose computing processor and any hardware accelerators, such as RTL, FPGA, AI, and deep learning processors). Based on the available processing capacity of the native processor at the device computer, the general purpose processor at the server, and the accelerator processor at the server, the system can allocate processing overhead and/or computational tasks among the three processors to avoid or minimize processing queues at any stage. In one embodiment, the system may allocate up to X ms to the native processor, up to Y ms to the general purpose processor, and up to Z ms to the accelerator processor, where X+Y+Z=<Lₜ, where Lₜ represents the desired upper bound for the combined computation and transmission latencies. By replicating redundant code at each processor, the respective processing loads may be statically allocated among the three processors based on, for example, the observed total latencies for the sample data sets processed using each API. Alternatively, the processing loads and/or the duration of the previously allocated processing windows (X, Y, Z) may be dynamically re-allocated based on latency values observed during steady state operation.

In another embodiment, some or all of the start-up protocols may be run as background processes, updating the aforementioned array as appropriate. By interrogating the network environment either continuously, periodically, or in response to predetermined events or triggers, the system may dynamically reconfigure the network connection to exploit the network connection having the then-currently lowest latency. By storing the array in non-volatile memory, the system may default to the last best connection and/or configuration to avoid start-up delays. The system can then switch to the optimum network connection after scanning available resources even while the eye tracker is operational.

According to some embodiments, the present disclosure is related to a system, comprising: an eye tracking camera device configured to obtain image data from a user, the image data comprising one or more images of a face of a user (could include redacted areas only comprising regions around the eyes or even a single eye in some embodiments); a network device configured to: control the eye tracking camera device and transmit the image data to a remote server hosted by a cloud service provider; and a service provider system (also referred to as a server, cloud based processor, hosted platform, or remote processing system) configured to: determine a position of an eye region of the user using the one or more images of the face; and transmit to the network device the position of the eye region, the network device being further configured to transmit to the service provider only a portion of future images of the face that corresponds to the position of the eye region. In contrast, presently known eye tracking systems transmit image data from the camera to the native processor onboard the client computer and process the image data locally or process image data on an embedded processor inside the camera.

According to some embodiments, the present disclosure is related to a system, comprising: a processor; and a memory for storing executable instructions, the processor executing the instructions to: determine a position of an eye region of a user using one or more images of a face obtained by an eye tracking camera device which are forwarded by a network device that is coupled with the eye tracking camera device and the system; transmit to the network device the position of the eye region; and receive from the network device only a portion of future images of the face that corresponds to the position of the eye region. According to some embodiments, the present disclosure is related to a method, comprising: receiving, from a network device, image data from a user, the image data comprising one or more images of a face of a user, the image data being obtained from an eye tracking camera device; determining a position of an eye region of the user using the one or more images of the face; transmitting to the network device the position of the eye region; and receiving only a portion of future images of the face that corresponds to the position of the eye region.

The systems and methods disclosed herein provide improved eye tracking through the use of cloud-based processing, in addition, to disclosing methods for reducing computing and network overhead, such as reducing upload requirements. Generally, decoupling of eye tracking camera device camera(s) from end user devices (e.g., herein referred to generally as network devices) as disclosed herein, as well as decoupling of eye tracking processing from the eye tracking camera devices and/or the end user devices allows for eye and gaze processing at the cloud-level. Processing at the cloud-level reduces the need to maintain eye tracking logic at the device level, as well as increases rapid implementation of updates to eye tracking logic from a central location in the cloud. In sum, the systems and methods disclosed herein allow for more ubiquitous use of eye tracking camera devices with any end user devices, with processing being provided in the cloud. In some embodiments, processed eye tracking data (e.g., eye and gaze data) can be delivered back to the eye tracking camera devices and/or the end user devices (e.g., network device such as a desk top computer, lap top computer, or tablet computer). The eye and gaze data can be used to control operations of the network device as well. For example, an eye tracking camera device can be used to control an application running on a tablet computer. In one embodiment, the user's eye movements could be used to control functions of a web browser on any network device.

Additionally, while decoupling the eye tracking logic from the end user level device is advantageous, these processes and/or systems disclosed herein can be further enhanced by using specific schemas that allow for reduced network and/or computing overhead. For example, capturing and processing high-resolution images in a cloud-environment as disclosed herein can result in network latency (due to image uploading times) and increased image processing overhead, especially when eye tracking is desired at real-time or near-real-time speed. Thus, embodiments herein overcome these issues through predictive eye tracking methods, as well as image redaction processes. These and other advantages of the present disclosure are provided in greater detail herein.

Turning now to the drawings, FIG. 1 depicts an illustrative architecture 100 in which techniques and structures of the present disclosure may be implemented. The illustrative architecture 100 may include an eye tracking camera device 102, a network device 104 (e.g., end user or native device), a service provider system 106, and a network 108. The network 108 may include any one or a combination of multiple different types of networks, such as cable networks, the Internet, wireless networks, and other private and/or public networks. In some instances, the network 108 may include cellular, Wi-Fi, or Wi-Fi direct. In some embodiments, some computations or functionalities disclosed herein can be executed entirely at the service provider system or cloud-level. In other embodiments, some computations or functionalities disclosed herein can be executed cooperatively by the eye tracking camera device 102, the network device 104 (e.g., end user device), the service provider system 106, while communicating over the network 108.

In some embodiments, the eye tracking camera device 102 and the network device 104 each comprise a processor and memory. The memory stores instructions that are executed by the processor to perform aspects of the eye and gaze tracking, as well as eye tracking camera device control as disclosed herein. When referring to operations executed by either of the eye tracking camera device 102 and the network device 104 it will be understood that this includes the execution of instructions by their respective processors. Also, processes executed at the service provider system or cloud level will be understood by one of ordinary skill in the art to include execution through distributed computing elements.

In various embodiments, the eye tracking camera device 102 is a stand-alone device that can be communicatively coupled with the network device 104 through any suitable wired or wireless connection (for example Bluetooth or USB). In other embodiments, the eye tracking camera device 102 and could be integrated into the network device 104 such that they function as a single device.

According to some embodiments, the network device 104 can include any suitable end user device such as a laptop, desktop computer, smartphone, tablet or other equivalent device. Broadly, the network device 104 is configured to control operations of the eye tracking camera device 102. For example, the network device 104 can control the eye tracking camera device 102 to obtain image data, such as photographs or images of the user's or users' face(s). This could include actuating mechanisms on the eye tracking camera device 102 to rotate, pivot, tilt, angle, or otherwise align an eye tracking camera 112 of the eye tracking camera device 102 with a face of the user. In other embodiments, the eye tracking camera device 102 is a fixed position device and control of the eye tracking camera device 102 includes causing a camera of the eye tracking camera device 102 to obtain images of the face of the user.

In general, the eye tracking camera device 102 can comprise an image sensor 103, one or more lenses 105, and one or more near infrared (IR) illuminators 107. In some embodiments, the eye tracking camera device 102 can also include a communications interface 109 for utilizing the network 108.

In general, predictive positioning is a methodology whereby a user's face, or position of an eye region, or the eyes can be predicted into the future, anticipating movement by the user. In various embodiments, the network device 104 can control movement of the eye tracking camera device 102 to achieve a desired camera position corresponding to a predicted eye location. Additional details on determining eye regions and using predictive positioning are provided below, but in general, this allows for predicting future eye position based on a past location of the eye region(s) and user movement.

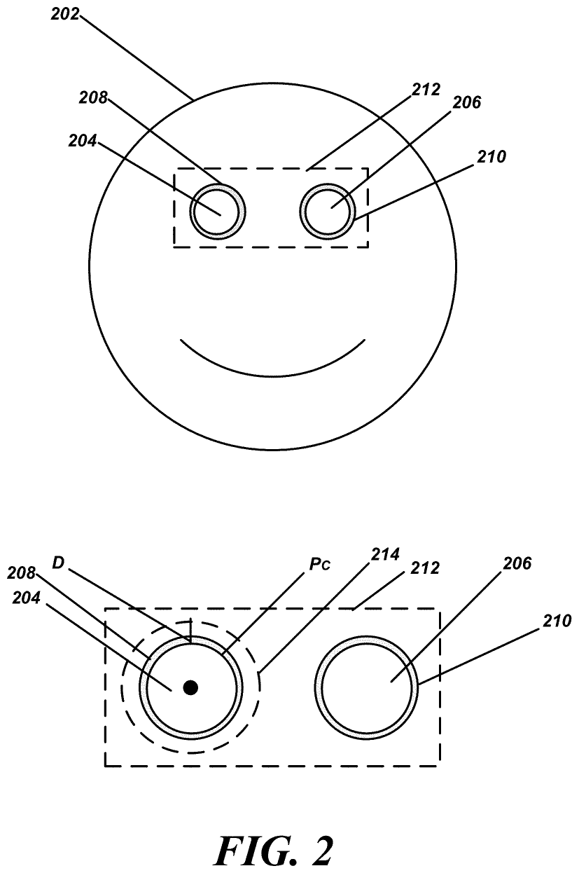

The network device 104 generally transmits image data (e.g., face or redacted images) obtained from the eye tracking camera device 102 to the service provider system 106 for image processing. Broadly, the service provider system 106 processes the image data obtained by the eye tracking camera device 102 using an image and eye gaze processor 110. The image and eye gaze processor 110 can be in the form of distributed computing hardware, process, and/or logic that is used to perform functions such as evaluating an image of a user's face to determine an eye region of one or both user eyes. The logic can also be configured to determine a position of an eye region, as well as define threshold distances around the eye region. These bounded areas are used to reduce the amount of image data transmitted from the network device 104 to the service provider system 106, as discussed in greater detail below with reference to FIG. 2. Also, it will be understood that in some embodiments, the image processing could also occur on eye tracking camera device 102 and/or the network device 104, or cooperatively between the eye tracking camera device 102, the network device 104, and the service provider system 106.

In general, the service provider system 106 can isolate an eye region using the one or more images of the face. The service provider system 106 can also transmit to the network device 104 the position of the eye region. The network device 104 then can obtain and transmit to the service provider 106 only a portion of future images of the face that corresponds to the position of the eye region(s). Thus, the network device 104 can redact or crop a full image of a face obtained by the eye tracking camera device 102 and transmit only a subset if the image data (e.g., the eye region(s)) as opposed to the full image of the face. These redacted portions of the full image of the face are then used to generate eye and gaze data, such as positions of the eyes, which are utilized by the network device 104 to control the eye tracking camera device 102.

Turning now to FIG. 2 (with reference to elements of FIG. 1), a user has a face 202 with two eyes 204 and 206 which are captured in an image obtained by the eye tracking camera device 102. In various embodiments, one or more images of the face 202 are initially captured by the eye tracking camera device 102 and transmitted to the service provider system 106 via the network device 104. Initially, the service provider system 106 determines eye regions within the one or more images of the face 202 such as eye regions 208 and 210, which roughly correspond to areas where eyes 204 and 206 are present. Thus, the image of the face in its entirety is used by the service provider system 106 to initially detect the eye regions 208 and 210. The methods can include using only one image of the face 202 in some embodiments, and does not require previous frames/images to find an eye. The methods implemented by the service provider system 106 provide robust operation across multiple eye image types irrespective of specific iris color, skin color, pupil size, contacts, glasses, and the like. The methods may include pattern recognition, machine learning (ML), look-up tables, neural networks, artificial intelligence (AI), feature identification, and other image processing techniques which may be implemented algorithmically. In some embodiments, the service provider system 106 is configured to determine precise measurements of pupil center and pupil size of each eye 204 and 206. In various embodiments, the service provider system 106 is configured to calculate a distance between the user and the eye tracking camera device 102 using only images of the face 202 that include the eyes 204 and 206.

Once the eye regions 208 and 210 are found, the service provider system 106 identifies a position of each eye region 208 and 210 relative to the full image of the face 202 and transmits this positional data back to the network device 104. It is assumed that the eye tracking camera device 102 obtains images of the same or substantially the same dimensional size each time an image is obtained. Thus, the location of each eye region 208 and 210 can be determined relative to features of the face or other landmarks within the full images. The positional data for the eye region 208 and 210 can be represented as X and Y Cartesian coordinates in some embodiments, and may also include distance information (generally orthogonal to the X,Y coordinate plane). Again, these X and Y coordinates can be measured relative to the full images obtained by the eye tracking camera device 102. To be sure, the eye tracking camera device 102 can obtain these full images and the network device 104 can then crop this full image down to the desired portions.

According to some embodiments, while some examples provided herein illustrate and describe tracking the eye region around both eyes, the eye tracking system can be configured to track a single eye of the user, allowing the user to control aspects of the network device with a single eye. This single eye tracking can also allow for independent operations by each eye. For example, one eye can control a first function of the network device while a blinking of a second eye could perform a second function of the network device.

In some embodiments, the network device 104 utilizes this positional data to crop or redact future images of the face 202 so that only a portion of future images of the face 202 that corresponds to the position of the eye regions 208 and 210 are transmitted back to the service provider system 106. In some embodiments, the eye region that is retained from the complete image of the face includes a segment 212 of the face 202 of the user that is bounded by a threshold area around the position of the eye region(s). In some embodiments, the segment 212 can include a bounded area that encloses the eye regions 208 and 210. The shape and size of the bounded area of the segment 212 can vary according to operational requirements, such as an upload capability of the network 108 or the processing capacity of the service provider system 106.

In another embodiment, more than one segment can be used. For example, the segment 212 can be subdivided into two segments, one for each eye region 208 and 210. A smaller bounded area of the segment(s) results in a smaller amount of image data being transmitted to the service provider system 106 by the network device 104. As mentioned above, this redaction process reduces the amount of image data that is transmitted over the network 108 by the network device 104 to the service provider system 106, which reduces network latency and reduces computation time by the service provider system 106, as the service provider system 106 is allowed to work with image data that includes only a portion of the images that corresponds to the position of the eye region. In this example, the portion would include the segment 212.

In various embodiments, as illustrated in the enlarged portion of the face of FIG. 2, a size of the threshold area could be defined by a threshold distance D obtained around each eye, measured from the pupil center P_{C}. This would result in a smaller segment 214 relative to segment 212. As noted above, the threshold area could include a shape that encompasses both eye regions 208 and 210 as represented by the segment 212.

Once the coordinates or positions of the desired segment (such as segment 212) are calculated relative to the initial images of the face 202, the service provider system 106 provides these coordinates or positions to the network device 104. As noted above, the network device 104 uses these coordinates to crop or redact future data frames obtained using the eye tracking camera device 102 such that only the desired segment is provided to the service provider system 106.

As noted generally above, in some embodiments, the eye tracking camera device 102, network device 104, and service provider system 106 can function cooperatively to provide real-time or near-real-time image processing for eye gaze tracking. In instances of real-time or near-real-time processing, the service provider system 106 can implement predictive positioning algorithms that predict a future position of the eye region of one or more of the eyes 204 and 206 based on a past or most recent position of an eye/eye region. In general, the predictive positioning analyzes previously located positions of the eye regions as a basis for determining potential future positions of the eye regions. Stated otherwise, the service provider system 106 can predict a future position of a pupil of an eye using extrapolation techniques based on previous data frames. Using a sufficient number of recent pupil positions, the service provider system 106 can use polynomial regression fitting to derive a polynomial curve that smoothly approximates movement of the pupil with respect to time. The service provider system 106 can use first and second derivatives at an endpoint of the approximating polynomial to calculate a likely position of the pupil farther ahead in time. Using this data, the service provider system 106 directs the network device 104 to control movement of the eye tracking camera device 102 to anticipate future eye positions.

In various embodiments the eye tracking software running on the local client computer may be configured to algorithmically isolate the eye region and only upload a predetermined region, for example the region around the eyes. In addition, data compression techniques may be employed such as transmitting differential data sets corresponding to the differences between successive frames; that is, only those pixels which changed from one frame to the next need be sent instead of all pixels including the unchanged ones. The software may also use predictive techniques such as extrapolation algorithms which estimate future eye position and/or movement based on previous position, velocity, profile matching or pattern recognition, or time derivatives of position or speed information as well as other functions thereof (e.g., polynomial fit with adjustable coefficients). In addition, a various input and/or control parameters (e.g., number of input points, the order of the polynomial, one or more of the coefficient values) may be dynamically adjustable to achieve a desired accuracy and/or confidence level. That is, the software may be configured to selectively allocate (increase or decrease) the number of linear or non-linear eye position data points (and/or their coefficients) until satisfactory predictive results are obtained. For example, if the predictive algorithms overshoot, undershoot, or otherwise do not coincide with actual position data or a false prediction occurs, the parameters may be adjusted until the predictive data matched the observed data. Alternatively, the predictive modules may be run in parallel as background processes until a desired degree of correspondence is achieved between computed and observed position data. Other embodiments contemplate the use of individual (this user) and/or aggregate data to train AI systems or otherwise adaptively control the predictive features. By employing various combinations of the data reduction, formatting, compression, and arrangement techniques described herein, the computational latency of the image processing subsequently performed at the remote server may be substantially reduced.

In various embodiments, the service provider system 106 can implement methods for detecting when the user's face or eye regions are not within view of the eye tracking camera device 102, and execute responsive processes to re-determine the eye regions. Searching methods can be performed in response to determining that the eye regions are not within view of the eye tracking camera device 102.

Thus, in addition to predictive position analysis, the service provider system 106 can be configured to determine when one or more of the eye regions 208 and/or 210 are no longer in the image data being provided by the network device 104. In various instances, the service provider system 106 can implement thresholding. That is, the service provider system 106 can be configured to determine that the eye region(s) is no longer in the image data. For example, the user may move from a field of view of the eye tracking camera device 102 for a period of time that exceeds a threshold. In one example, the user may move from a field of view of the eye tracking camera device 102 for more than five seconds (any time frame can be implemented). The field of view can include any size view frustum that can be captured by the eye tracking camera device 102 and will vary according to the capabilities of the eye tracking camera device 102.

When the service provider system 106 determines that the eye regions are not within the field of view for the period of time specified, the service provider system 106 can execute a searching process. Thus, when the eye region(s) is/are no longer in the image data, the service provider system 106 can then instruct the network device 104 to control the eye tracking camera device 102 to obtain one or more additional images of the entire face of the user. That is, instead of using the smaller subset of the image as disclosed above, one or more full images are used by the service provider system 106. The service provider system 106 then re-determines the position(s) of the eye region(s) from the one or more additional full images of the face of the user. In some embodiments, the service provider system 106 can execute this searching process on a period or scheduled basis, rather than relying on a triggering condition or event. In general, a trigger could be conditioned on events such as a loss of view of the eye or eye region, a lack of network connectivity for a period of time, a malfunction in the eye tracking camera device 102 or the network device 104, a deviation from a normal eye movement envelope, or other similar condition(s).

In another embodiment, the service provider system 106 is configured to determine a position of an eye region of a user using one or more images of a face obtained by an eye tracking camera device which are forwarded by a network device that is coupled with the eye tracking camera device and the service provider system 106. The service provider system 106 is configured to transmit to the network device the position of the eye region, and further to receive from the network device only a portion of future images of the face that corresponds to the position of the eye region.

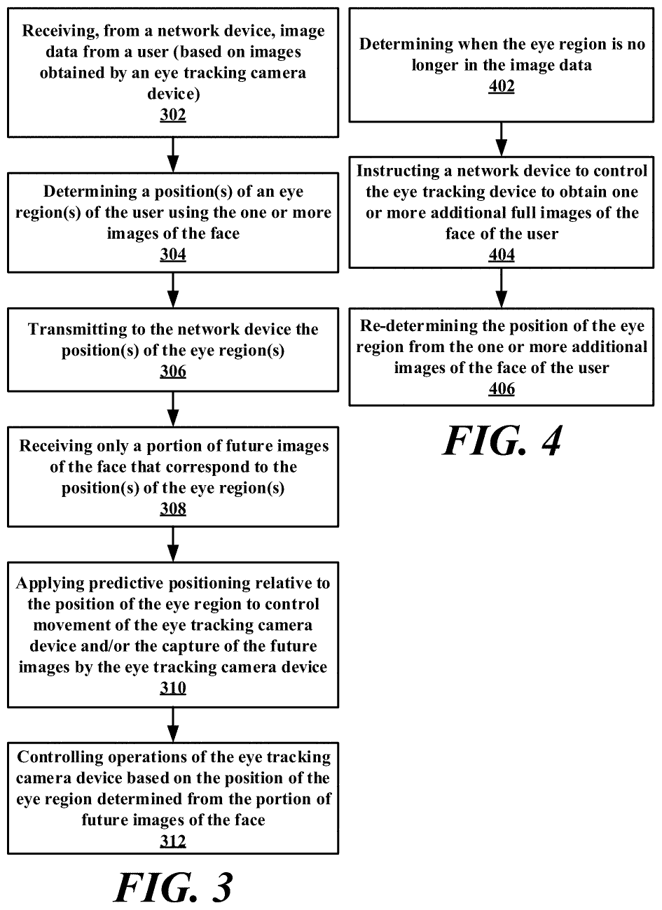

FIG. 3 is a flowchart of an example method that can be performed in accordance with the present disclosure. The method will be generally understood as being performed by a service provider system as disclosed herein. The method includes a step 302 of receiving, from a network device, image data from a user. As noted throughout, the image data comprises one or more images of a face of a user. In various instances, the image data is obtained from an eye tracking camera device that can be coupled with the network device.

Next, the method includes a step 304 of determining the location of an eye region of the user using the one or more images of the face. This can include measuring or assessing a location or position of the eye region(s) relative to other facial features or relative to Cartesian coordinates of the full face image initially obtained by the eye tracking camera device. After the position(s) of the eye region(s) is(are) found, the method includes a step 306 of transmitting to the network device the position(s) of the eye region(s). In one or more embodiments, the method includes a step 308 of receiving only a portion of future images of the face that corresponds to the position(s) of the eye region(s). Thus, the service provider system receives a smaller data set in the subsequent image data provided by the network device as compared to the initial image or images used to by the service provider system to determine the position(s) of the eye region(s).

It will be understood that the process or method disclosed can be performed in a real-time or near-real-time basis. In these embodiments, the method includes a step 310 of applying predictive positioning relative to the position of the eye region to control at least one operation the network device. The predictive positioning can be used to predict a future position of the eye regions of the user to be found in future images captured by the eye tracking camera device. To be sure, step 310 is an optional step in some embodiments.

In various embodiments, the method includes an optional step 312 of controlling operations of the eye tracking camera device based on the position of the eye region determined from the portion of future images of the face. This control process or step can be performed by the service provider system when it transmits eye and gaze data to the network device. The eye and gaze data could include a position of the eye regions determined by the service provider system analyzing the portion of future images of the face. The network device can control the eye tracking camera device in response to the eye and gaze data received from the service provider system. In other embodiments, the eye tracking camera device always sends full frames to the network device regardless of any feedback from the other system components.

FIG. 4 is a flowchart of a method that can be used to search for an eye using a system of the present disclosure. The method can include a step 402 of determining when the eye region is no longer in the image data. This process or step can include identifying when the eye region is no longer in the image data when the user moves from a field of view of the eye tracking camera device for a period of time that exceeds a threshold.

Next, the method includes a step 404 of instructing a network device to control the eye tracking camera device to capture and transmit one or more additional full images of the face of the user. The method then includes a step 406 of re-determining the position of the eye region from the one or more additional images of the face of the user. Again, this process can be performed on a periodic basis, rather than in response to a triggering condition.

Referring now to FIG. 5, an exemplary start-up routine 500 configured to run on the client computer. The initialization steps include performing a network scan to identify available and compatible processing resources (Step 502). The routine enters a unique identifier associated with each server or server array, such as an IP address, access code, or the like into a database, data structure, resource array, table, list, spreadsheet, or other suitable memory device or structure such as the array shown in FIG. 6 (described in greater detail below (Step 504)). The start-up routine also records the location of each cloud based server (Step 506), for example in the form of geo-coordinates, and the distance between the resource and the client device.

With continued reference to FIG. 5, the client software populates the resource array with information relating to all or a subset of the following attributes, along with additional ones as appropriate, for each resource (Step 508): hosting entity; upload speed; general purpose processor and/or accelerated hardware chip set manufacturer, type, and/or configuration details; image processing software code version or release number; current network traffic volume; tariff or fee information (if any); ping response time value; available access ports; and application programming interface (API) protocols (Step 510).

In some embodiments, an exemplary data set may be sent to each resource using its associated API, and the time required to process the data and return a response is recorded in the resource array (Step 512). The resource candidates may then be ranked in order of increasing latency, and a connection established with the resource having the lowest latency (Step 514). If desired, the initialization process may continue to operate in the background updating the resource array to permit dynamic reconfiguration of the network connection during use (Step 516).

Referring now to FIG. 6, an exemplary resource array 600 may be implemented in tabular form, with each row corresponding to a unique resource, and each column corresponding to one of the attributes described above in connection with FIG. 5.

An eye tracking system is thus provided which includes: a client computer including a display panel, a native processor, and a network interface module; and a camera comprising an image sensor, a lens, and an illuminator, the camera being mounted proximate a bottom edge of the display panel. The native processor is configured to: operate the camera to record first and second facial image data frames on the image sensor; establish a network connection between the network interface module and a remote image processor; transmit the first data frame to the remote image processor; receive a first eye region derived from the first data frame from the remote image processor; determine a second eye region for the second data frame based on the first eye region; and transmit the second eye region of the second data frame to the remote image processor.

In an embodiment, the native processor is configured to discard that portion of the second data frame which lies outside of the second eye region.

In an embodiment, transmitting the second eye region comprises transmitting only the second eye region.

In an embodiment, the native processor is configured to: operate the camera to record successive facial image data frames on the image sensor; recursively isolate respective eye regions for each facial image data frame based on previous eye region information received from the remote image processor; and transmit successive eye regions to the remote image processor.

In an embodiment, the native processor is configured to: receive eye location information corresponding to each successive data frame from the remote image processor; and operate the camera to position the image sensor in accordance with eye location information for a previous data frame.

In an embodiment, the native processor is configured to predict the eye location for a future data frame based on eye location information from a previous data frame.

In an embodiment, the native processor is configured to adjust the camera position in accordance with the predicted eye location.

In an embodiment, the native processor is configured to algorithmically predict future eye location using a polynomial expression incorporating eye location information for previous data frames.

In an embodiment, the native processor is further configured to: receive an indication from the remote image processor that eye location information cannot be derived from a corresponding eye region for at least one successive data frame; in response to the indication, suppress isolating the eye region from the remainder of the data frame for a series of data frames; transmit the entire facial image for the series of data frames to the remote image processor; and thereafter recalibrate an eye region for a subsequent data frame after receiving eye location information from the remote image processor corresponding to the series of data frames.

In an embodiment, the native processor is further configured to establish the network connection with a selected one of a plurality of available remote image processors based on corresponding latency values.

In an embodiment, the native processor is further configured to determine respective latency values for the plurality of available remote image processors using an initialization algorithm.

In an embodiment, the initialization algorithm, upon execution by the native processor, causes the system to: perform a network scan to identify said plurality of available image processors; retrieve geo-coordinates for each available image processor; compute the distance between the client computer and each image processor using the geo-coordinates; and assign a geo-latency value to each image processor based on its distance from the client computer; and establish the network connection with a selected one of the image processors based on the geo-latency values.

In an embodiment, the initialization algorithm causes the system to: elicit respective ping trace values for each available image processor; and establish the network connection with a selected one of the image processors based on the geo-latency values and the ping trace values.

In an embodiment, the initialization algorithm causes the system to: identify a respective application programming interface (API) protocol for each available image processor; transmit a predetermined data frame to each image processor using its API protocol; assign a payload trace value to each available image processor based on its computed response to the predetermined data frame; and establish the network connection with a selected one of the image processors based on at least one of the geo-latency values, the ping trace values, and the payload trace values.

In an embodiment, the initialization algorithm causes the system to populate a resource array with indicia of at least one of the following attributes for at least one of the available image processors: hosting entity; upload speed; general purpose processor configuration; geo-latency values; accelerated hardware chip configuration; software version; network load; tariff information; ping tracer value; available access ports; and payload tracer value.

In an embodiment, the initialization algorithm causes the system to establish the network connection with a selected one of the image processors based on one or more of said attributes.

A method is also provided for reducing computational and transmission latencies for an eye tracking camera coupled to a client computer configured to interact with a cloud based server through a network connection. The method includes reducing computational latency by: capturing sequential data frames of facial images at the client computer; sending at least a subset of each data frame to the server for image processing; receiving eye region and eye location information from the server for each frame; determining a subset of a data frame based on previous eye region information; and positioning the camera to capture a future data frame based on previous eye location information. The method further includes reducing transmission latency by establishing the network connection with a selected one of a plurality of available servers based on their respective transmission latency values.

In an embodiment, reducing transmission latency further comprises: determining respective distance values between the client computer and each of the plurality of available servers; assigning geo-latency values to each server based on its distance value; and establishing the network connection with the selected server based on the geo-latency values.

In an embodiment, reducing transmission latency further comprises: determining at least one of a ping trace value and a payload trace value for each of the plurality of available servers; and establishing the network connection with the selected server based on one or more of the geo-latency values, the ping trace values, and the payload trace values.

An eye tracking computer is provided which includes: a display panel; a native processor; a network connection module; and a camera having an image sensor. The native processor is configured to: transmit sequential data frames to a remote image processor, where each data frame comprises at least a portion of a facial image; receive eye region information from the remote image processor for each of the sequential data frames; determine that portion of each facial image which includes the eyes based on previously received eye region information; identify, for each of a plurality of remote image processors, at least one of a geo-latency value, a ping trace value, and a payload trace value; and establish a connection between the network connection module and a selected one of the remote image processors based on at least one of the geo-latency, a ping trace, and a payload trace values.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that stores computer-executable instructions is computer storage media (devices). Computer-readable media that carries computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. An eye tracking system, comprising:
a client computer including a display panel, a native processor, an eye tracking assembly, and a network interface module;
wherein the eye tracking assembly includes an image sensor, a lens, and an illuminator; and
wherein the native processor is configured to:
operate the image sensor to record first and second facial image data frames;
establish a network connection, using the network interface module, between the client computer and a remote image processor;
transmit the first facial image data frame to the remote image processor
receive, from the remote image processor, a first eye region data set derived from the first facial image data frame;
derive a second eye region data set from the second facial image data frame using information obtained from the first eye region data set; and
transmit the second eye region data set to the remote image processor.

2. The eye tracking system of claim 1, wherein the native processor is configured to discard that portion of the second facial image data frame which is not included in the second eye region data set.

3. The eye tracking system of claim 1, wherein transmitting the second eye region data set comprises transmitting only data that is within the second eye region data set, and not transmitting the portion of the second facial image data frame which is not included in the second eye region data set.

4. The eye tracking system of claim 1, wherein the native processor is further configured to:
record successive facial image data frames on the image sensor;
recursively isolate respective eye region data sets for each successive facial image data frame based on information received from the remote image processor; and
transmit successive eye region data sets to the remote image processor.

5. The eye tracking system of claim 4, wherein the native processor is further configured to:
receive, from the remote image processor, eye location information corresponding to at least one successive facial image data frame transmitted to the remote image processor; and
predict the eye location for a future facial image data frame based on eye location information received from the remote image processor for a previous facial image data frame.

6. The eye tracking system of claim 5, wherein the native processor is configured to position the image sensor in accordance with eye location information for a previous facial image data frame.

7. The eye tracking system of claim 6, wherein the native processor is configured to adjust the position of the image sensor in accordance with the predicted eye location.

8. The eye tracking system of claim 6, wherein the native processor is configured to algorithmically predict future eye locations using a polynomial expression incorporating eye location information from previous facial image data frames.

9. The eye tracking system of claim 8, wherein the native processor is further configured to:
receive an indication from the remote image processor that eye location information cannot be derived from a corresponding eye region data set for at least one successive facial image data frame;
in response to the indication, suppress discarding for a series of data frames;
transmit the entire facial image data frame for the series of data frames to the remote image processor; and
thereafter recalibrate an eye region data set for a subsequent facial image data frame after receiving eye location information from the remote image processor corresponding to the series of data frames.

10. The eye tracking system of claim 1, wherein the native processor is further configured to establish the network connection with a selected one of a plurality of available remote image processors based on respective latency values associated with the plurality of remote image processors.

11. The eye tracking system of claim 10, wherein the native processor is further configured to determine the respective latency values for the plurality of remote image processors using an initialization algorithm.

12. The eye tracking system of claim 11, wherein the initialization algorithm, upon execution by the native processor, causes the system to:
perform a network scan to identify said plurality of available image processors;
determine respective geo-coordinates for at least two of the available image processors;
compute a respective distance between the client computer and each of the at least two image processor using their respective geo-coordinates; and
assign a geo-latency value to each of the at least two available remote image processors based on its distance from the client computer; and
establish the network connection with a selected one of the available image processors based on the geo-latency values.

13. The eye tracking system of claim 12, wherein the initialization algorithm causes the system to:
elicit respective ping trace values for each available image processor; and
establish the network connection with a selected one of the available image processors based on the geo-latency values and the ping trace values.

14. The eye tracking system of claim 13, wherein the initialization algorithm causes the system to:
identify a respective application programming interface (API) protocol for each available image processor;
transmit an initialization data frame to each available image processor using its API protocol;
measure each available image processor's response to the initialization data frame;
assign a payload trace value to each available image processor based its measured response; and
establish the network connection with a selected one of the available image processors based on the geo-latency values, the ping trace values, and the payload trace values.

15. The eye tracking system of claim 14, wherein the initialization algorithm further causes the system to populate a resource array with indicia of the following attributes for at least one of the available image processors: hosting entity; upload speed; geo-latency values; accelerated hardware chip configuration; ping tracer value; available access ports; and payload tracer value.

16. The eye tracking system of claim 15, wherein the initialization algorithm causes the system to establish the network connection with a selected one of the available image processors based on said attributes.

17. A method of reducing computational and transmission latencies for an eye tracking camera coupled to a client computer, the computer configured to interact with a cloud based server through a network connection, the method comprising the steps of:
mitigating computational latency by:
capturing sequential data frames of facial images at the client computer;
sending a subset of each data frame to the server for image processing;
receiving eye region and eye location information from the server for each data frame; and
determining a subset of a current data frame based on eye region information for a previous data frame; and
mitigating transmission latency by establishing the network connection with a selected one of a plurality of available servers based on their respective transmission latency values.

18. The method of claim 17, wherein reducing transmission latency further comprises:
determining respective distance values between the client computer and each of the plurality of available servers;
assigning geo-latency values to each server based on its distance value; and
establishing the network connection with the selected server based on the geo-latency values.

19. The method of claim 18, wherein reducing transmission latency further comprises:
determining at least one of a ping trace value and a payload trace value for each of the plurality of available servers; and
establishing the network connection with the selected server based on the geo-latency values, the ping trace values, and the payload trace values.

20. An eye tracking computer, comprising:
a display panel;
a native processor;
a network connection module; and
a camera having an image sensor;
wherein the native processor is configured to:
transmit sequential data frames to a remote image processor, where each data frame comprises at least a portion of a facial image;
receive eye region information from the remote image processor for each of the sequential data frames;
define a region of each facial image which includes the eyes based on eye region information from a previous facial image;
identify, for each of a plurality of remote image processors, at least one of a geo-latency value, a ping trace value, and a payload trace value; and
establish a connection between the network connection module and a selected one of the remote image processors based on at least one of the geo-latency, a ping trace, and a payload trace values.
